(19) United States
(12) Patent Application Publication
(10) Pub. No.: US 2005/0019141 A1
(43) Pub. Date: Jan. 27, 2005

(54) Separation device

(75) Inventor: Marius Cornelis De Baat, Bergschenhoek (NL)

Correspondence Address: Steven M. Koehler;Westman, Champlin & Kelly, Suite 1600, 900 Second Avenue South, Minneapolis, MN, 55402-3319, US

(73) Assignee: Logitec Plus B.V., Capelle a/d Ijssel (NL)

(21) Appl. No.: 10/875,525

(22) Filed: Jun. 24, 2004

(30) Foreign Application Priority Data
Jun. 26, 2003 (NL) 1023756

(51) Int. Cl. B65G 65/04

(52) U.S. Cl. 414/412

(57) ABSTRACT

A device for separating a sheet-shaped packaging from the material packaged therein, particularly bulk goods, comprising a drum and a driver adapted for driving the drum about a center line thereof, wherein the drum forms an accommodation space for the packaged material and is provided at the inside with blades for ripping apart the packaging, wherein the drum at a first end is provided with a supply opening for the packaged material and at an opposite second end is provided with a stopper for stopping the packaged product.

The present application is based on and claims the benefit of the Netherlands patent application Serial No. 1023756, filed Jun. 26, 2003, the contents of which are hereby incorporated by reference in its entirety.

### BACKGROUND OF THE INVENTION

The invention relates to a device for separating a sheet-shaped packaging from material packaged therein, particularly bulk goods.

Bulk goods, loose or compressed, are usually packaged in paper or foil, in bags or bales. The bulk goods may be a raw material, for instance peat or another substrate, generally a nutrient or raw material.

The user of the bulk goods or mass goods has to separate the packaging from the material. It is of great importance that this separation takes place as perfectly as possible, in order to prevent problems or higher costs in the processing of waste material.

For the producer of the packaged products it may also be necessary to remove the packaging, when the sell-by date has passed or when the packaging does not meet the requirements. In these cases as well a perfect separation is required.

The packaging is often separated by cutting it open and removing the material. This is laborious, however.

There are also installations for removing the packaging, which installations are adapted to a certain shape, size or type of packaging. For the treatment of other packagings the installation has to be adjusted and/or some actions have to carried out manually. When, as is usually the case, the packaging is placed on a pallet, the packaging first has to be separated from the pallet as well.

### SUMMARY OF THE INVENTION

It is an object of the invention to provide a device of the type mentioned in the preamble by which means the packaging can reliably be separated from the packaged material.

A further object of the invention is to provide a device of the type mentioned in the preamble by which means the packaging can easily be separated from the packaged material.

Yet a further object of the invention is to provide a device of the type mentioned in the preamble by which means the packaging and packaged material can easily and reliably be separated from an optional pallet.

A further object of the invention is to provide a device of the type mentioned in the preamble by which means packagings of various shapes and/or contents can easily and reliably be separated from the packaged material.

A further object of the invention is to provide a device of the type mentioned in the preamble by which means both packagings can be separated from the packaged material and the material can be loosened as well.

At least one of these objects according to the invention is achieved in the form of a device for separating a foil-shaped packaging from the material packaged therein, particularly bulk goods, comprising a drum and means for driving the drum about a center line thereof, wherein the drum forms an accommodation space for the packaged material and is provided at the inside with blades for ripping apart the packaging, wherein the drum at a first end is provided with a supply opening for the packaged material and at an opposite second end is provided with means for stopping the packaged product.

Thus the packaged product can remain in its place in axial direction during the revolving of the drum and thus be intensively engaged by the blades. Packaged products of various shapes and contents may be introduced into the drum for processing. The device, particularly the drum, may in this case have a small length and therefore be highly compact.

Preferably the device is furthermore provided with means for tilting the drum about a horizontal axis perpendicular to the drum centre line, as a result of which the drum may be set at a position such so as to enhance one or several of the steps in the process.

The tilting means may preferably be adapted for tilting the drum to a position declining from the first end. As a result not only the feeding into the drum is facilitated, but it is also achieved that the packaging always abuts the second end. In the initial stage of removal of the packaging the blades will thus be intensively active in the same area.

Alternatively or additionally the tilting means may be adapted for tilting the drum to a position declining toward the first end, as a result of which the discharge of the packaging from the first end is enhanced.

The removal of the packaging is further enhanced when at least a part of the blades is disposed at the inside of the drum, in the second end thereof, spaced apart from the center line by a distance that is smaller than the diameter of the drum. Thus the (end) surface of the packaging situated at that location can also be engaged.

For enhancing the loosening of the material the second end of the drum may be closed.

The ripping apart and removal of the packaging is enhanced when the drum has a circumferential wall, wherein blades are disposed at the inside of the circumferential wall in an inclined position with respect to the centre line. The inclined position of the blades rotating along with the drum may be cooperative in pulling the packaged products into the revolving drum. The inclined blades may furthermore push the packaged products against the second end as a result of which the blades at that location are more effectively active.

The separation of the material and the packaging can be enhanced when the drum has a circumferential wall that is permeable in radial direction, so that the separated and loosened material can quickly be discharged from the drum and that said material cannot hamper the further separation and loosening process. With the drum according to the invention the sieving process (the sieving out of irregularities such a pieces of wood from the material) of the loosened material can take place more effectively.

In a simple construction of the drum, the circumferential wall is formed by perforated plates on which the blades are disposed.

The device may furthermore comprise a first conveyor placed directly below the drum for collecting and discharging material that has fallen out of the drum.

In a compact embodiment of the device according to the invention the first conveyor is provided with driving means for transport underneath the drum and away from the feed side, where the first end of the drum is situated.

The device may furthermore comprise a collector for the sheet-shaped packaging, said collector being placed in front of and below the feed side. The sheet-shaped packaging may thus be discharged at the side facing away from the discharge of the contents.

Preferably the blades are not just shaped for ripping apart the packaging but are also shaped for loosening the material. The blades may be triangular for that purpose.

In a further development of the device according to the invention it furthermore comprises a supplier for packaged products, wherein the supplier comprises first and second support means that are transverse to each other, for supporting respective sides of the packaged products that are transverse to each other, wherein the supplier is tiltable between a receiving position in which substantially the first support means are active and the packaged products can be received and a discharging position in which substantially the second support means are active and the packaged products can be discharged to the feed end of the drum. The device is thus further mechanised, which improves the efficiency.

Preferably the first support means comprises a pallet support, particularly a pallet fork, by which means packaged products supported on a pallet can be processed directly from the pallet.

Efficiency is furthermore enhanced when the second support means comprise a transport surface, preferably also means for driving the transport surface.

In a compact embodiment, the supplier is positioned adjacent to the packaging collector when in the receiving position, and the supplier is positioned above the packaging collector when in the discharging position.

Preferably the drum driving means are adapted for selectively driving the drum in two directions, so that taking the left packaging out of the drum is enhanced, particularly in case of an inclined position of the blades and a position of the drum tilted towards the feed end.

### BRIEF DESCRIPTION OF THE DRAWINGS

The invention will be elucidated on the basis of an exemplary embodiment shown in the attached drawings, in which:

FIG. 1 shows a schematic vertical view of an exemplary embodiment of a device according to the invention;

FIG. 2 shows a schematic top view of the device of FIG. 1; and

FIG. 3 shows a partial end view according to arrow III in FIG. 1.

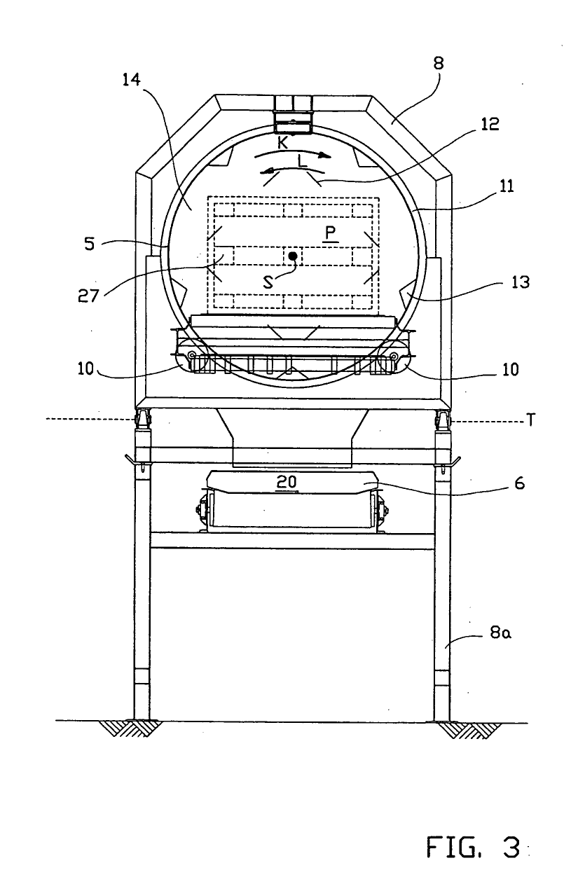

### DETAILED DESCRIPTION OF THE PREFERRED EMBODIMENTS

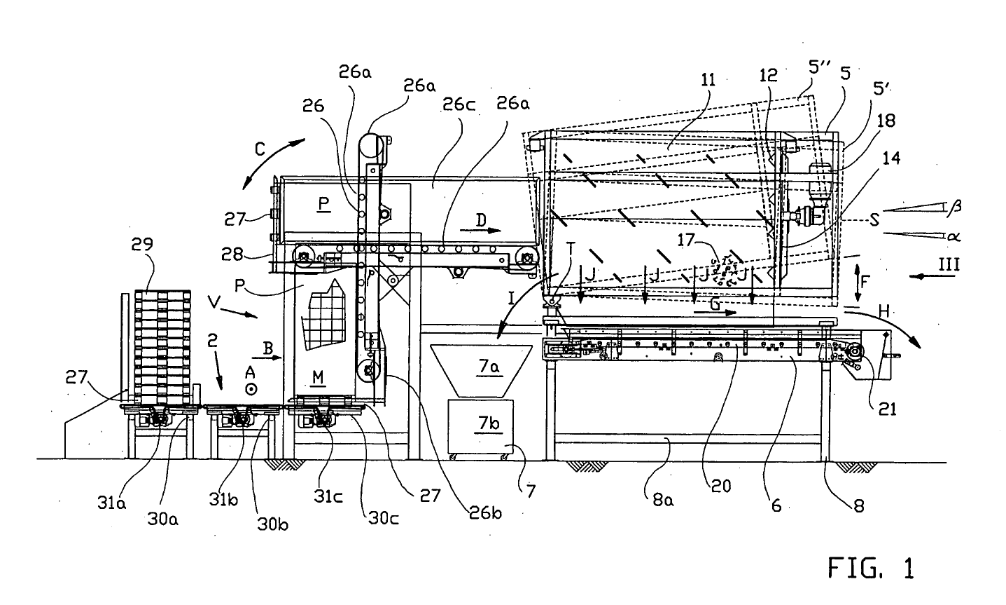

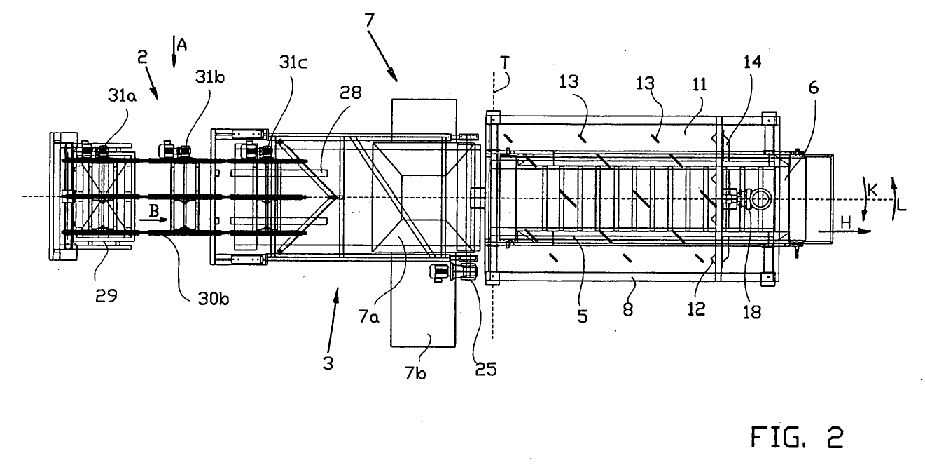

The device 1 shown in FIGS. 1 and 2 for separating a packaging V from packaged material M in packaged products P, in this example in the so called big bale shape, comprises a supplier 2, having chain tracks 30a-c, on which the packaged products P, supported on pallets 27, can be placed and supplied to the further parts of the device 1. Each chain track 30a-c has its own separately controllable motor 31a-c.

Above and adjacent to the chain track 30c a supplier/tilting device 3 is placed, which is provided with a frame 4 that is tiltable about an axis U and is provided with a fork 28 for engaging into the pallets of the packaged products P, and with a support/conveyor surface 26 provided with a conveyor belt 26a that circulates about rollers 26a,b and is driven by means of a motor 25. The frame 4 furthermore has side plates 26c.

On the right-hand side of the tilting device 3, as considered in the drawing, a mobile collection tray 7 is placed below for empty packagings V, which collection tray comprises a feed funnel 7a and a storage 7b, in which a press may be provided. Optionally, the funnel 7a may be attached to the frame 8 and the storage 7b underneath it may be mobile.

On the right-hand side thereof, as considered in the drawing of FIG. 1, a frame 8 is positioned on which a drum 5 is arranged by, for example, an actuating device so as to be tiltable about horizontal axis T, between positions 5′ and 5″. Below the drum 5 a discharge conveyor 6 has been placed, comprising a belt 20 circulating in direction G, driven by motor 21.

The drum 5 is substantially circle-cylindrical and has a casing 11 formed out of plates provided with perforations 17 (only a few of which are shown), which casing 11 is supported on support rollers 10 arranged in the frame 8. By means of a motor 18 or driver engaging on a closed rear side 14, the drum 5 is rotated in either the direction K or in the direction L about center line S.

The right-hand end of the drum 5, as considered in the drawing of FIG. 1, is adapted with a stopper for stopping the packaged product P. For example, the drum 5 is closed by a plate 14. Inwardly extending blades 12 are attached on the plate 14. Likewise, blades 13 are attached on the inner circumference of the casing 11. The blades 12 and 13 are substantially triangular, having a cutting tip. As shown in FIGS. 1 and 2 the blades 13 are placed inclined with respect to the drum center line.

In operation a packaged product P including its pallet is placed on the chain conveyor 30b of supplier 2 by means that are not further shown. This may take place from a lateral side, from the direction A.

By activation of the motors 31b,c the packaged product P is moved in the direction B, to the supplier/tilting device 3 and on the chain conveyor 30c. The fork 28 engages in/under the pallet 27. Subsequently the tilting device 3 is operated for rotation about axis U in the direction C. During this rotation the packaged P is supported on the pallet for as long as the weight is not taken over by the conveyor surface 26.

Once tilted in the horizontal position the conveyor belt 26a is operated, for moving the packaged product P in the direction D. The right-hand end of the conveyor belt 26a extends to near or into the entrance or the feed end of the drum 5. The drum 5′ is then tilted slightly downward about axis T and then held at an angle α of for instance 5°. This facilitates the feeding of the packaged product P into the interior of the drum 5′.

During feeding the packaged product P, the drum is rotated in the direction K, as a result of which the packaged product, which is engaged on the packaging V by the blades 13, is as it were pulled into the drum 5′.

When the packaged product P is fully received in the drum 5′, the supplier/tilting device 3 is tilted back about axis U, in order to be ready for receiving a next packaged product P.

Meanwhile the drum 5′ is rotated further in the direction K, wherein the packaged product P is pressed against the end wall 14 and thus against the blades 12 attached on it.

As a result of gravity the packaged product P will not or only to a limited extent rotate along with the drum 5′, but fall back again and again.

The blades 12 and 13 ensure a cutting of the packaging V and subsequent loosening of the material M. The loosened material M exits from the cuts in the packaging V and falls through the holes 17 in the casing 11 and onto the belt 20 of the conveyor 6 (arrow J), that is driven for discharge of the material to the right (G). At the end of the conveyor 6 the material is discharged to a collector that is not further shown.

The packaging V is left behind in the drum 5′, and when no more material M is present in the drum 5′, the drum at the closed end 14 is lifted in the direction F in order to tilt about hinge T, to the discharging position 5″ shown in FIG. 1, in which the centre line S is at an angle β of for instance 10° to the horizontal. By subsequently rotating the drum 5″ in opposite direction L, the packaging V is urged out of the drum in a direction I, to be collected in collector 7 and to be discharged later on. The packaging material V, being almost free of material residues, may simply be compressed and discharged.

Meanwhile the tilting device 3 has rotated back and the pallet 27 has been moved over the chain tracks 30b and 30c to chain track 30a, in order to be accommodated there in pallet stack 29 which can be discharged later on. After that a next product P is supplied from direction A and placed on the chain track 30b, in order to be processed in the manner as described above.

Instead of big-bales smaller bags of packaged product can also be treated, optionally several at a time.

It is observed that for enhancing the effect, blades of various shapes can also be used simultaneously.

Although the present invention has been described with reference to preferred embodiments, workers skilled in the art will recognize that changes may be made in form and detail without departing from the spirit and scope of the invention.

1. A device for separating sheet-shaped packaging from the material packaged therein, particularly bulk goods, comprising a drum and a driver adapted for driving the drum about a center line thereof, wherein the drum forms an accommodation space for the packaged material and is provided at the inside with blades for ripping apart the packaging, wherein the drum at a first end is provided with a supply opening for the packaged material and at an opposite second end is provided with a stopper for stopping the packaged product.

2. The device according to claim 1, furthermore provided with an actuating device for tilting the drum about a horizontal axis perpendicular to the drum center line.

3. The device according to claim 2, wherein the actuating device is adapted for tilting the drum to a position declining toward the first end.

4. The device according to claim 1, wherein at least a part of the blades are disposed at the inside of the drum, in the second end thereof, spaced apart from the center line by a distance that is smaller than the diameter of the drum.

5. The device according to claim 1, wherein the second end of the drum is closed.

6. The device according to claim 1, wherein the drum has a circumferential wall, wherein the blades are disposed at the inside of the circumferential wall in an inclined position with respect to the center line.

7. The device according to claim 1, wherein the drum has a circumferential wall that is permeable in radial direction.

8. The device according to claim 6, wherein the circumferential wall is formed by perforated plates, on which the blades are disposed.

9. The device according to claim 1, furthermore comprising a first conveyor placed directly below the drum for collecting and discharging material that has fallen out of the drum.

10. The device according to claim 9, wherein the first conveyor is provided with a driver for transport underneath the drum and away from the feed side, where the first end of the drum is situated.

11. The device according to claim 10, furthermore comprising a collector for the sheet-shaped packaging, said collector being placed in front of and below the feed side.

12. The device according to claim 1, wherein the blades are shaped for loosening the material.

13. The device according to claim 1, wherein the blades are triangular.

14. The device according to claim 1, furthermore comprising a supplier for the packaged products, wherein the supplier comprises first and second supports that are transverse to each other, for supporting respective sides of the packaged products that are transverse to each other, wherein the supplier is tiltable between a receiving position in which substantially the first support is active and the packaged products can be received and a discharging position in which substantially the second support is active and the packaged products can be discharged to the feed end of the drum.

15. The device according to claim 14, wherein the first support comprises a pallet support, particularly a pallet fork.

16. The device according to claim 14, wherein the second support comprises a transport surface, preferably also a driver for driving the transport surface.

17. The device according to 14, furthermore comprising a collector for the sheet-shaped packaging, said collector being placed in front of and below the feed side, wherein in the receiving position, the supplier is positioned adjacent to the packaging collector and in the discharging position the supplier is positioned above the packaging collector.

18. The device according to claim 1, wherein the driver adapted for driving the drum is adapted for selectively driving the drum in two directions.
